(19) United States
(12) Patent Application Publication
(10) Pub. No.: US 2025/0345820 A1
(43) Pub. Date: Nov. 13, 2025

(54) Programmable Mesh Wi-fi Solar Powered Sprinkler System

(71) Applicant: RLD Resources, LLC, Boerne, TX (US)

(72) Inventors: Ruben V. Losoya, Boerne, TX (US); David L. Caton, Boerne, TX (US); Oscar Lynn Caton, Boerne, TX (US)

(21) Appl. No.: 18/662,690

(22) Filed: May 13, 2024

(51) Int. Cl. B05B 12/04; B05B 12/00; B05B 15/00

(52) U.S. Cl. CPC B05B 12/04; B05B 12/004; B05B 15/00

(57) ABSTRACT

A wi-fi enabled, solar powered autonomous sprinkler system is disclosed, comprising a plurality of stations. Each station has a solar panel connected to a batter to power the system, and a power supply which steps down voltage to a logic circuit which provides a wi-fi signal. The logic circuit stores data from sensors, and sends signals based on predefined parameters programed therein by a user through a wi-fi enabled controller. Once the parameters are entered, the controller can be disconnected from the system, and the logic circuit sends command signals based on the entered parameter to operate the solenoid valves to turn the system on and off. A bridge wi-fi is in communication with the logic circuit to allow programming of the system and connection to third party wi-fi enabled devices.

### BACKGROUND

### 1. Field of the Invention

The present invention relates to solar powered wi-fi operated sprinkler systems, and particularly to a solar powered wi-fi mesh operated sprinkler system that can be operated without being in constant communication with the controller.

### 2. Description of the Related Art

With conventional water sprinkler systems, various valve stations are installed on the property where it is desired to water, and electric copper wires are run from a control station to each valve station to open and close the valves. It is very typical in these installations to have the copper wires erode over time in the ground, and it is also common for these copper wires to be severed during landscaping, construction, or repair of the water pipes running between each station. Such damage requires repair in the form of rerunning a new electrical line from the controller into the ground and into the valve station, which could be several feet away. This requires a lot of digging, and is very labor-intensive. Alternatively, the line is repaired via splicing, which compromises the integrity and efficiency of the copper wire.

Attempts have been made by others to do away with traditionally powered water sprinkler systems by employing both solar power and Bluetooth, RF, BTLE, or wi-fi operated systems. Others have developed wireless solenoid networks that are attached to the valves, and require sensors to communicate with the transceivers, and generally requires replacement of a conventional solenoid with the entirely different solenoid, and requires constant communication with a controller to operate the system.

Others have disclosed using a mobile app to communicate with a wi-fi network of a system to both record data and program data. However, the system requires, in most instances, that the app interface with the wi-fi network so that valve sensors are placed in communication with wireless transceivers that communicate through wi-fi.

Others have developed sprinkler systems that rely on Bluetooth technology to communicate between valve stations and with a controller, which must be within Bluetooth connectivity of the system. However, these systems are not desirable in that they operate on a point-to-point system. Therefore, if a component such as the solenoid, transceivers, or communication sensor is malfunctioning or broken, stations which are not adjacent to one another cannot communicate with one another because connection with the intervening and broken station is lost.

It is therefore desirable to create a sprinkler system that is both solar powered, and operates on a mesh network such that nonadjacent stations can communicate with one another. It is further desirable to design a system where each valve station has its own wi-fi network in communication with the other wi-fi networks of this system, as well as the wi-fi network of an existing house or commercial building. It is further desirable to create a sprinkler system where each component of each station resides within the cap space of the valve cap, such that each station is itself a stand-alone station, but also in mesh wi-fi communication with the other stations of the system.

It is further desirable to create a water sprinkler system wherein each valve station contains its own logic and memory to receive information from sensors within the sprinkler system, and to receive data from the sensors and power sources, and record the same locally within the memory. It is further desirable to create a system where the parameters of the system may be programmed by interface with an app or other graphic user interface to program the parameters within each station of the system, but without need to have a controlling mechanism constantly in wireless communication with the wi-fi mesh system.

### SUMMARY

The present invention is different than the prior art. The present invention is designed such that each station of a sprinkler system comprises its own autonomous and wireless system that also communicates with the other stations of the system to form a wi-fi mesh network, or to extend a wi-fi mesh network from an existing structure such as a house or a commercial building. The components of each station are maintained within the lid or cap of a valve station and are water sealed therein.

The present system comprises a solar panel on an outer surface of a lid to a station and is in communication and connected to a power supply on the inner surface of the lid to the station. The power supply of the present invention is contemplated to be a lithium-ion battery or other similar power supply. The power supply is connected to a logic circuit which provides a wi-fi signal as well as functions as logic for operating the station and storing and receiving information from the sensors of the valve. The logic is in communication with power supply charged by the solar panels. A relay and a solenoid valve are in communication with a logic circuit, which is used to operate the solenoid valve. The logic circuit is mounted on a PC board and placed within the bottom side of the lid of the station and is in communication with all the various components, such as the solar panel, the battery charge unit, the valve, and other sensors.

In one embodiment, the wi-fi produced by the logic circuit is in communication with an existing wi-fi network of a home or commercial building, and extends the signal within the sprinkler system. In another embodiment, within each station, the logic circuit is in communication with a second bridge wi-fi. The bridge wi-fi circuit within the lid of the station provides a bridge wi-fi for third-party devices to connect. Thus, in the present system, it may be possible to have the system communicate with wi-fi operated devices such as outdoor lights, gates, wi-fi enabled water pumps, wi-fi cameras and other wi-fi enabled devices. Such a configuration is advantageous. For instance, if it is desired, a particular station may be configured to communicate with a third-party wi-fi operated outdoor light to turn on the light when desired, or programed to turn on the light whenever that station is operating to water the grass.

Moreover, because each station comprises its own hardware and wi-fi signal, each station is not only operable by itself, but serves as a pass-through to extend or create a mesh network wherein nonadjacent stations may be able to communicate with one another in the event that an intervening station has suffered some mechanical or software failure, such as having dead solar cells, a dead battery, a malfunctioning logic circuit, or a faulty solenoid. Moreover, because each station has its own memory, a user interface is needed to program each station as to the various parameters that are desired, but after programming, the interface need not be present to operate the system. In other words, after programing, no controller is needed to operate the system. The memory within each station operates its own station to water, and can operate or not operate pursuant to the parameters programmed by the user during the user interface.

It is contemplated that in addition to time, date, and watering times, that the logic circuit can be programmed to communicate with various sensors as desired, such as sensors that communicate with the logic circuit to determine ground moisture, water/rain, temperature sensor for fires and/or freezing conditions, and other parameters desired. Thus, in addition to being able to detect the battery voltage, and program watering times any other parameter could be programmed within the logic circuit as desired.

It is contemplated that the present system could work within 5 to 10 individual stations being a part of the present system. However, fewer or greater number of units could be contemplated.

A station of the present invention comprises a solar panel attached to the outer surface of the lid of the station, and is connected to a power supply such as a lithium ion battery, which stores the voltage needed to ultimately turn on and off the valve one desired. The power supply is in communication with the logic circuit and the voltage of the battery is stored therein, the logic circuit is further in communication with a bridge wi-fi circuit for connecting third-party devices to the station and/or system of the present invention.

The logic circuit selects the valve direction and powers the solenoid valve by providing a ground to the circuit using a N-MOSFet device. The N-MOSFet uses a small voltage to provide a ground to the circuit, thereby actuating the circuit to select the valve direction (open or close) and power the valve to actuate. The devices are not required to be at the same positive potential, but the control signals from the controller are of the same potential. A power supply is in communication with the logic circuit to power the logic circuit.

The solar cell has a detector circuit which operates a N-MOSFet to allow the solar cell to charge the battery when the solar cell output is at or above a preset voltage.

Each station within the system communicates with one another via the mesh network created by the plurality of stations and each emitting their own wi-fi, and each station being in communication with one another as well as any pre-existing wi-fi source from a house or commercial building.

### BRIEF DESCRIPTION OF THE DRAWINGS

FIG. 1 is a schematic view of a system of the present invention.

FIG. 2 is a diagram of the components of a single station of the system of the present invention.

FIG. 3 is a diagram of the programing of the system of the present invention.

FIG. 4 is a diagram of the programing of various sensors of a station of the present invention.

FIG. 5 is a schematic view of the components of a station of the present invention.

FIG. 6 is a diagram of the communication of the components of the present invention.

### DETAILED DESCRIPTION

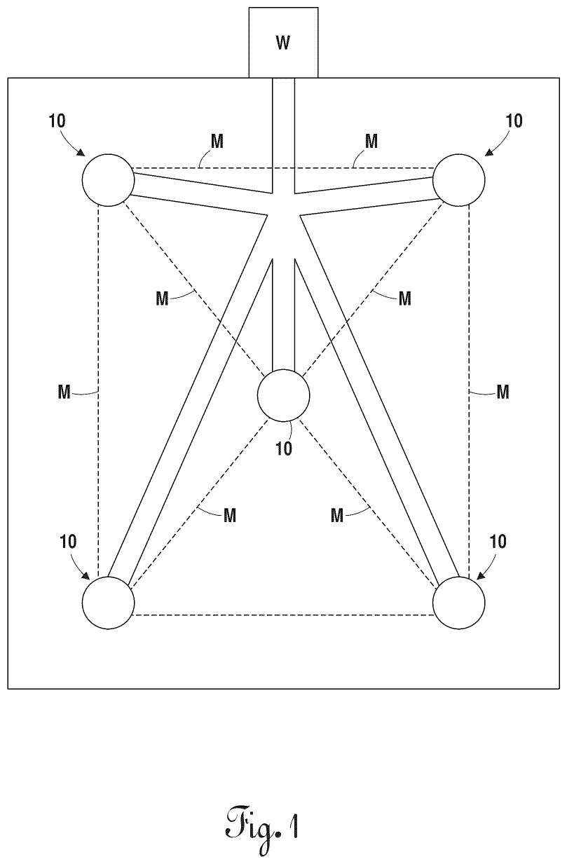

FIG. 1 is a schematic view of a system of the present invention with multiple stations 10 in wi-fi mesh communicating with one another via the mesh wi-fi M created by a wi-fi component (not shown) within logic circuit 16. Each station 10 comprises its own logic circuit with wi-fi16. As described herein, other than the solar panel 12, it should be understood that all of the components of the system of the present invention are stored in a substantially water-tight sealed manner within the underside of the lid (not shown) of the station 10. The advantage of the present system over the prior art is twofold. First, while a controller 30 is required to provide a graphic user interface (GUI) to initially program each station 10, after programming, the controller 30 can be removed from the wi-fi network, and the system will still operate. This is achieved because each station 10 has its own memory within logic circuit 16. Second, if the wi-fi within logic circuit 16 of any given station 10 fails, that station 10 may not operate until the wi-fi is restored, but the adjacent and nonadjacent stations will continue to work and communicate with one another via wi-fi, thereby creating a mesh network wherein not each station 10 may be operation, but the operational stations 10 continue to operate and communicate with one another.

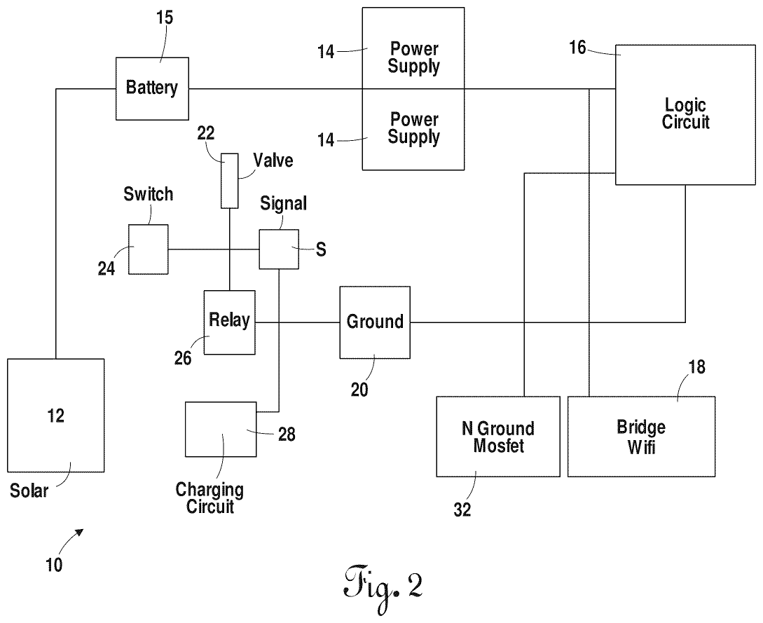

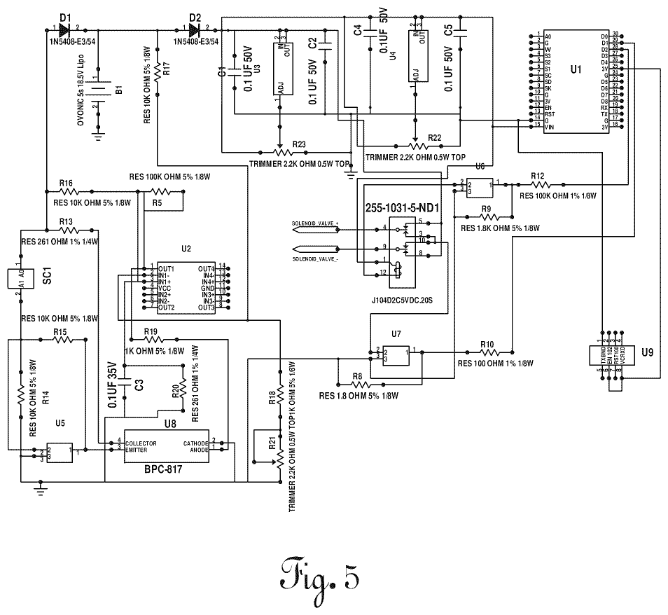

Turning to FIGS. 2 and 5, a schematic and flow diagram of a typical installation within a station 10 is disclosed. A solar panel 12 is located on the outer surface of the lid and attached thereto. The solar panel 12 is connected on the inside surface of the lid to a battery 15. One power supply 14 is used to power the logic circuit 16, the relay 26, and the solar panel's 12 cell circuit (not shown). Another power supply 14 is used to power the solenoid valve when operated. It is contemplated by the present invention that the battery 15 will be 21V lithium-ion batteries due to their superior ability to maintain a charge and relatively lightweight and slim profile. However, any suitable power supply 15 may be used. The power supplies 14 preferably step down the voltage provided from the battery to 9 volts for the logic circuit 16, the relay 26, and the solar panel's 12 cell circuit, and 5 volts to power the solenoid valve 22 when operated.

The power supply 14 is connected to the logic circuit 16. The logic circuit 16 stores its own memory of the different sensors and other circuits within the system, and initiates all the relevant signals to either operate the system or retrieve data from the various sensors. The logic circuit is connected to a N-MOSFet 32 on the ground side of relay 26 and another N-MOSFet 32 is connected to the ground side of the solenoid valve 22. The relay 26 is actuated and N-MOSFet for the solenoid valve 22 is actuated to turn on the solenoid valve 22. Only the N-MOSFet for the solenoid valve 22 is actuated to turn off the solenoid valve 22.

Each station 10 further has a bridge wi-fi 18, in one embodiment, which is in communication with logic circuit 16, and serves as a wi-fi bridge to connect any third-party device 38 to the system of the present invention. All possibilities of third-party devices 38 are not shown in the present application, but could include any wi-fi enabled third-party device 38 that would typically be found at a house or a structure where the system is installed. For example, bridge wi-fi 18 could connect to wi-fi outdoor lighting, a wi-fi enabled security system, a wi-fi operated gate, a wi-fi operated water pump, or other wi-fi enabled devices. In one embodiment logic circuit 16 also contains all of the timing data of a station 10. However, in an alternative embodiment, a separate timing circuit 34 is in communication with logic circuit 16 to provide timing data, GPS information, and similar information to the system.

Charging circuit 28 is in communication with logic circuit 16, and comprises an electronic circuit that monitors both the solar panel 12 and the Battery 15. Charge will flow from the solar panel 12 to charge the Battery 15 when the comparator circuit (not shown) determines the solar cell voltage is at or above the preset value. The battery 15 produces higher voltage than is needed for power source 14. The power source 14 takes the battery voltage which is constant and drops the voltage to the values needed for the solenoid valve 22 and the logic circuits 16.

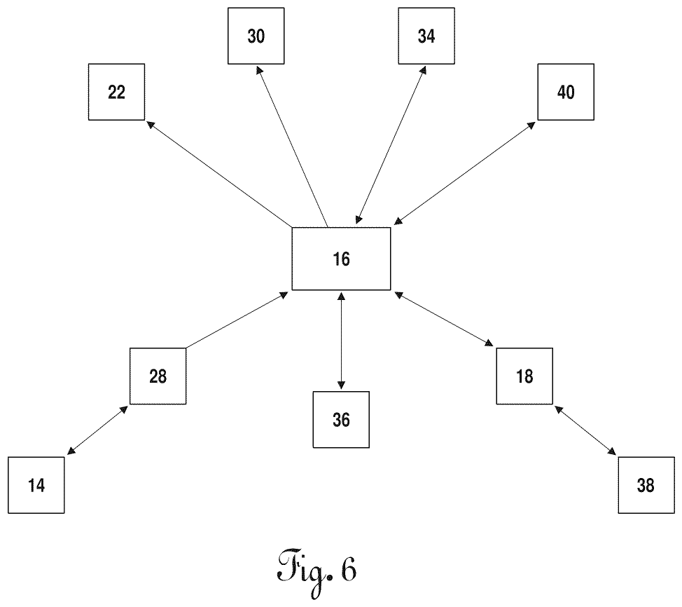

Turning to FIG. 6, further contemplated by the present invention that multiple sensors to provide data to the logic circuit 16 may be incorporated into the system of the present invention, or, at the discretion of the user, left out. For instance, moisture sensor 36 can be placed in the soil in a location to communicate with logic circuit 16 via wi-fi to provide information to be stored in the logic circuit 16 to determine the moisture content of the soil at any given time. Furthermore, a heat sensor 40 can be placed in the soil and in communication with logic circuit 16 to determine the soil temperature, and logic circuit can be programmed to turn on in the event the temperature gets to a level where fire may be present or fire conditions may exist. Furthermore, in periods of rain, the moisture sensor may provide information to the logic circuit 16 such that the logic circuit 16 can override the other program commands to keep the system from watering and conditions are such that watering is not needed.

The controller 30 of the present system is only required to interface with the wi-fi during programming of each logic circuit 16 of each station 10, and thereafter can be disconnected from the wi-fi, and can communicate via cellular network with the logic circuit 16 of each station 10 through a graphic user interface. In some embodiments, the GUI occurs via a custom-designed mobile application, but pre-existing mobile applications such as Mighty Mule, Renology, DC Home, or do-it-yourself apps like IOT MQTT. It is contemplated that the controller 30 communicates with the wi-fi emitted by the mesh created by logic circuit 16 of each station 10 via consumer or commercial RF modulated formats such as (but not limited to) wi-fi 802.11B, G, N 2.4 GHz, wi-fi 802.11, N 5 GHz, wi-fi HaLOW 802.11 ah, LORAWAN.

It is further contemplated that the wi-fi emitted by the logic circuit 16 contains at least the same security as the host wi-fi to which it connects, or if operated independently, at least WEP, WPA, NWPA2 security. In communicating with the wi-fi, the controller's 30 GUI via the app or other computer software mechanism has code on board device at as unique identification methods for each device it connects to for programming. It further automatic network address translation configuration and will automatically reconfigure as the network demands change. The interface via the app or other software system that interfaces to program the system has methods for message recovery, redundancy and can use ad hoc or predefined protocol such as MQTT. It further has the ability to read, react or report based on Digital I/O and analog I/O inputs, such as the GPS, detection of water flow from a flow sensor (not shown), moisture content from moisture sensor 36, temperature from heat sensor 40, self-diagnostics such as voltage measurements and current measurements, voltage outputs (AC or DC), contact outputs, etc.

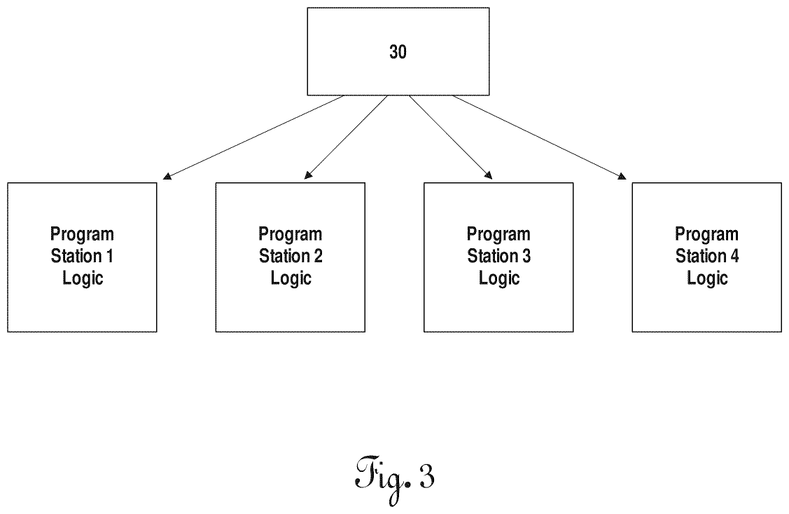

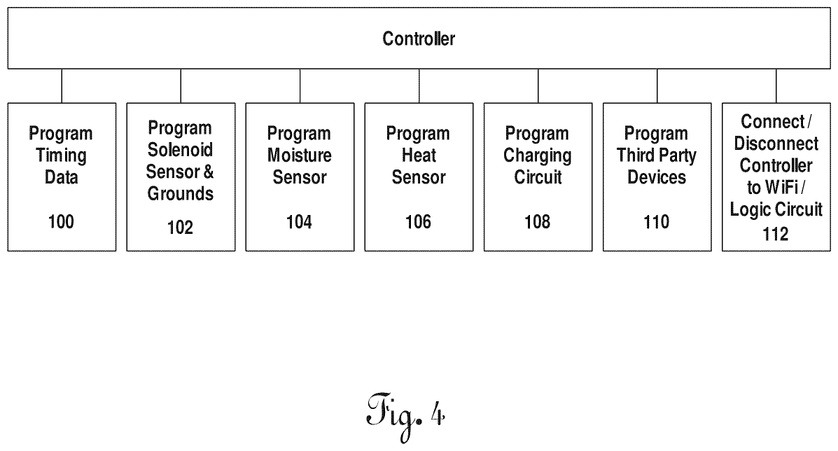

Turning to FIGS. 3 and 4, to initially program, or change the programming parameters of a system, the controller 30, through the wi-fi provided by the plurality of logic circuit 16 is in communication with logic circuits 16, and through the GUI provided by the controller 30, each station 10 is programmed by the user to the desired parameters. The controller 30 can detect at this stage device status, can set a device ID, and through timing circuit 34 can download time and date information and communicate the same over to logic circuit 16. The user can then set the date and time, and set the watering times desired as a turn on and turn off valve command within the app or software system.

The parameters as to the charging of the Battery 15 can be monitored by the logic circuit 16 through a voltage and current circuit 28, which communicates with the data to logic circuit 16, which is also programmed to retrieve data from moisture sensor 36, heat sensor 40, and any other sensor desired to be input into the system. Therefore, as shown in FIG. 4, a user would use controller 32 to connect and/or disconnect to the wi-fi through the logic circuit 112 and program timing data 100, program solenoid sensor on the solenoid valve 22 and ground operation for N-MOSFets 32, 102, program moisture sensor 104, program heat sensor 106, program charging circuit 108, and programming any third-party devices. The programming of third-party devices 110 occurs through the bridge wi-fi circuit 18, which communicates the commands back to logic sensor 16.

Once the parameters are set and the programming is done for each station 10, each station 10 via the wi-fi mesh created by the wi-fi signals through logic circuit 16 serves to allow adjacent and nonadjacent stations to communicate with each other and provide a mesh network that can operate any third-party device, and can even act as a cellular wi-fi for cellphones, tablets and other mobile devices. Furthermore, if the logic circuit 16, or the wi-fi in the logic circuit 16 fails in one station 10, the adjacent and nonadjacent stations 10 will reroute the wi-fi and continue to communicate with each other. The controller 30 is no longer needed because of the memory stored in each station 10 on the logic circuit 16, and all of the data from each station 10 stored in logic circuit 16 is communicated back to the non-connected controller 30 via cellular network (not shown).

The embodiments described herein are some examples of the current invention. It will be appreciated by those skilled in the art that changes could be made to the embodiments and features described above without departing from the broad inventive concept of the present invention. It is understood, therefore, that this invention is not limited to the particular embodiments disclosed, but it is intended to cover modifications within the spirit and scope of the present invention. Among other things, any feature described for one embodiment may be used in any other embodiment. Also, unless the context indicates otherwise, it should be understood that when a component is described herein as being connected to another component, such connection may be direct, or indirect, and with or without one or more intermediate components. The scope of the invention is defined by the attached claims and other claims that may have been drawn to this invention, and is not limited to specific examples described herein.

We claim:

1. A wi-fi operated and solar powered sprinkler system comprising:
a plurality of sprinkler valve stations wherein each station comprises:
a solar panel attached to a top surface of a lid to said station and connected to a battery to charge said battery;
at least one power supply in communication with a logic circuit and powering said logic circuit, a bridge wi-fi, at least one ground and a solenoid valve connected to and operating a sprinkler
wherein said logic circuit produces a wi-fi signal in communication with said bridge wi-fi and said logic circuit stores time and date information and operational parameters to turn said solenoid valve to an on position and an off position; and
wherein the wi-fi signal produced by each station communicates with adjacent and non adjacent stations to provide a wi-fi mesh network.

2. The wi-fi operated and solar powered sprinkler system of claim 1 wherein:
said at least one ground comprises a ground and an N-ground MOSFet in communication with said logic circuit and in communication with a relay;
wherein said relay is in communication with a switch and wherein said switch activates said solenoid valve to open or close said valve when a signal is sent from said logic circuit to said at least one ground.

3. The wi-fi operated and solar powered sprinkler system of claim 2 further comprising a timing circuit in communication with said bridge wi-fi and said logic circuit, said timing circuit storing timing data thereon.

4. The wi-fi operated and solar powered sprinkler system of claim 3 comprising a charging circuit in communication with said logic circuit, said solar panel and said battery and operates a comparator circuit to charge said battery in response to a charge command from said logic circuit.

5. The wi-fi operated and solar powered sprinkler system of claim 4 further comprising a moisture sensor in communication with said logic circuit, and said logic circuit retrieves moisture data from said moisture sensor at a predefined parameter.

6. The wi-fi operated and solar powered sprinkler system of claim 5 further comprising a temperature sensor in communication with said logic circuit, and said logic circuit retrieves temperature data from said temperature sensor at a predefined parameter.

7. The wi-fi operated and solar powered sprinkler system of claim 6 further comprising a controller in communication with said wi-fi via an interface with said bridge wi-fi to create predefined parameters with in said logic circuit for operation of said solenoid sensor, said timing circuit and said charging circuit.

8. The wi-fi operated and solar powered sprinkler system of claim 7 wherein said controller comprises a connect command and a disconnect command to connect and disconnect from said bridge wi-fi.

9. The wi-fi operated and solar powered sprinkler system of claim 8 further comprising a wi-fi enabled third party device connected to said bridge wi-fi.

10. A plurality of wi-fi operated and solar powered sprinkler stations in communication with one another to form a wi-fi operated sprinkler system, wherein each of said plurality of sprinkler stations comprises:
a solar panel attached to a top surface of a lid to said station and connected to a battery to charge said battery;
at least one power supply in communication with a logic circuit and powering said logic circuit, a bridge wi-fi, at least one ground and a solenoid valve connected to and operating a sprinkler
wherein said logic circuit produces a wi-fi signal in communication with said bridge wi-fi and said logic circuit stores time and date information and operational parameters to turn said solenoid valve to an on position and an off position; and
wherein the wi-fi signal produced by each station communicates with adjacent and non-adjacent stations to provide a wi-fi mesh network.

11. The plurality of wi-fi operated and solar powered sprinkler stations of claim 10 wherein:
said at least one ground comprises a ground and an N-ground MOSFet in communication with said logic circuit and in communication with a relay;
wherein said relay is in communication with a switch and wherein said switch activates said solenoid valve to open or close said valve when a signal is sent from said logic circuit to said at least one ground.

12. The plurality of wi-fi operated and solar powered sprinkler stations of claim 11 further comprising a timing circuit in communication with said bridge wi-fi and said logic circuit, said timing circuit storing timing data thereon.

13. The plurality of wi-fi operated and solar powered sprinkler stations of claim 12 comprising a charging circuit in communication with said logic circuit, said solar panel and said battery and operates a comparator circuit to charge said battery in response to a charge command from said logic circuit.

14. The plurality of wi-fi operated and solar powered sprinkler stations of claim 13 further comprising a moisture sensor in communication with said logic circuit, and said logic circuit retrieves moisture data from said moisture sensor at a predefined parameter.

15. The plurality of wi-fi operated and solar powered sprinkler stations of claim 14 further comprising a temperature sensor in communication with said logic circuit, and said logic circuit retrieves temperature data from said temperature sensor at a predefined parameter.

16. The plurality of wi-fi operated and solar powered sprinkler stations of claim 15 further comprising a controller in communication with said wi-fi via an interface with said bridge wi-fi to create predefined parameters within said logic circuit for operation of said solenoid sensor, said timing circuit and said charging circuit.

17. The plurality of wi-fi operated and solar powered sprinkler stations of claim 15 wherein said controller comprises a connect command and a disconnect command to connect and disconnect from said bridge wi-fi.

18. The plurality of wi-fi operated and solar powered sprinkler stations of claim 16 further comprising a wi-fi enabled third party device connected to said bridge wi-fi.
